(19) United States
(12) Patent Application Publication
(10) Pub. No.: US 2026/0050135 A1
(43) Pub. Date: Feb. 19, 2026

(54) PASSIVE THERMAL COMPENSATION THROUGH AUXETIC STRUCTURES

(71) Applicant: Rockwell Collins, Inc., Cedar Rapids, IA (US)

(72) Inventors: Jeffrey M. GRAYCZYK, San Diego, CA (US); James J. RICHARDSON, Temecula, CA (US); Gabriel Silva FIGUEROA, Sacramento, CA (US)

(73) Assignee: Rockwell Collins, Inc., Cedar Rapids, IA (US)

(21) Appl. No.: 18/802,660

(22) Filed: Aug. 13, 2024

(51) Int. Cl. G02B 7/00

(52) U.S. Cl. CPC G02B 7/008

(57) ABSTRACT

A method and device for passive athermalization in optical systems including at least one auxetic structure in at least one optical device. The at least one auxetic structure functions to counter or completely negate the increase in distance of at least one glass portion and at least one optical sensor plane of the optical device which results from expansion of the optical device when under a thermal load.

### FIELD OF THE INVENTION

The subject matter disclosed herein relates to devices and methods of manufacturing devices which address thermal stresses to optical systems. In particular, to structures which provide passive athermalization in optical systems by physically responding to thermal stress in a manner that counters or cancels out undesirable physical thermal responses from components of the optical system.

### BACKGROUND OF THE INVENTION

Thermal changes in optical systems in severe environments such as space and various other extraterrestrial atmospheres has proved challenging to address via conventional methods. As a result of thermal stress, the components of the relevant optical systems can undergo physical changes, such as, expansion or contraction which can cause degradation to the performance of the optical system.

Systems using active compensation for thermal gradients have been provided to address this challenge. These systems typically include complex motor and rail systems to adjust optics to retain the proper focus when handling thermal stresses. These systems are expensive and complex; where such complexity introduces additional failure points in the optical systems as a whole. Passive athermalization via 3D printed auxetic structures like those discussed herein which can remove the complexity and the downsides associated with these active systems is thus desirable.

### SUMMARY OF THE INVENTION

The present disclosure is directed, in a first aspect, to a method for passive athermalization in optical systems including providing at least one auxetic structure in at least one optical device, where the at least one optical device has at least one glass portion and at least one optical sensor plane spaced at a distance from each other. The method also includes exposing the at least one optical device to a thermal load, where the at least one optical device expands under the thermal load and increases the distance between at least one glass portion and at least one optical sensor plane. The at least one auxetic structure expands under the thermal load and reduces the distance between at least one glass portion and at least one optical sensor plane. The combination of the expansion of the at least one optical device and the expansion of the at least one auxetic structure results in no net change in distance between the at least one glass portion and as least one optical sensor plane.

In yet another embodiment, the present disclosure is directed to at least one auxetic structure in the at least one optical device which includes a hollow screw positioned within a housing where the at least one glass portion is positioned at the head of the screw and the at least one optical sensor plane is positioned on a nut which is attached to the threads of the screw which are positioned at the bottom portion of the screw. The optical device also includes at least one expansion rod where the at least one expansion rod connects the head of the screw to the housing. The expansion of the at least one expansion rod under the thermal load results in rotation of the screw in a direct which reduces the distance between the head of the screw and the nut.

Embodiments may also include a plurality of expansion rods connect the screw head to the housing.

In some embodiments, the plurality of expansion rods are positioned on the side of each flat face of the screw head.

In some embodiments, the at least one auxetic structure in the at least one optical device includes a cylindrical housing comprising an inner wall, an outer wall, at least one glass portion is positioned at a first end of the cylindrical housing, and at least one optical sensor plane positioned at a second end of the cylindrical housing where the first and second ends of the cylindrical housing are opposite each other. At least one auxetic structure is positioned between the inner wall and an outer wall and connects the inner wall to the outer wall. The expansion of the at least one auxetic structure under the thermal load results in force which pulls the top and bottom of the cylindrical housing closer together.

In some embodiments, the at least one auxetic structure includes at least one center portion, at least one long portion, and at least one short portion. The at least one long portion is connected to the at least one center portion and one of the inner wall, or outer wall of the cylindrical housing. The at least one short portion is connected to one of the at least one center portion and to a second center portion or to the first or second end of the cylindrical housing.

Still further, in some embodiments, the center portion is in the shape of a square and where connections of the at least one long portion and the at least one short portion to the at least one center portion are positioned in the center of the at least one center portion.

In some embodiments, a plurality of one auxetic structures are provided in sequence between the first and second ends of the cylindrical housing.

In some embodiments, the inner wall and outer wall of the cylindrical housing are connected to the first and second ends of the cylindrical housing via at least one expansion structure.

In some embodiments, the at least one expansion structure compresses or expands in response to the pulling force of the at least one auxetic structure and is suitable for allowing for the distances between the inner and outer side walls and the first and second ends of the of the cylindrical housing to vary but the distance between the first and second ends of the cylindrical housing remains constant when under thermal load.

In some embodiments, the at least one auxetic structure in the at least one optical device includes, at least one bimetallic curved strip positioned between at least one glass portion positioned at a first end of the optical device, and at least one optical sensor plane positioned at a second end of the optical device.

Still further, in some embodiments, the at least one bimetallic curved strip includes a first metal strip and a second metal strip. The first metal strip is made of the same metal or has the same coefficient of thermal expansion as the at least one optical device. The second metal strip is made of the same metal or has the same coefficient of thermal expansion as the as the at least one optical device. The first and second metal strips are made of metals with different coefficients of thermal expansion.

Still further, in some embodiments, the at least one optical device includes a plurality of bimetallic curved strips.

Still further, in some embodiments, the plurality of bimetallic curved strips are positioned end to end in a sequence wherein a direction of curvature for each bimetallic curved strip is oriented opposite the direction of curvature of each adjacent bimetallic curved strip such that an end of the first metal strip is positioned adjacent to an end of the second metal strip of each adjacent bimetallic curved strip.

Still further, in some embodiments, the sequence of the plurality of bimetallic curved strips positioned end to end extends around a circumference of the optical device.

Still further, in some embodiments, the at least one optical device includes a plurality of bimetallic curved strips sequences, wherein the plurality of bimetallic curved strips sequences are arranged along an optical axis of the at least one optical device and perpendicular to direction of the end to end bimetallic curved strips in a single sequence.

In yet another embodiment, the present disclosure is directed to an optical device including a cylindrical housing which includes an inner wall, an outer wall, at least one glass portion is positioned at a first end of the cylindrical housing, and at least one optical sensor plane positioned at a second end of the cylindrical housing where the first and second ends of the cylindrical housing are opposite each other. The optical device also includes at least one auxetic structure positioned between the inner wall and an outer wall and connecting the inner wall to the outer wall. The auxetic structure includes at least one center portion, at least one long portion, and at least one short portion. The at least one long portion is connected to the at least one center portion and one of the inner wall, or outer wall of the cylindrical housing. The at least one short portion is connected to one of the at least one center portion and to a second center portion or to the first or second end of the cylindrical housing.

In some embodiments, the inner wall and outer wall of the cylindrical housing are connected to the first and second ends of the cylindrical housing via at least one expansion structure.

In yet another embodiment, the present disclosure is directed to an optical device including a cylindrical housing which includes an inner wall, an outer wall, at least one glass portion positioned at a first end of the cylindrical housing, and at least one optical sensor plane positioned at a second end of the cylindrical housing where the first and second ends of the cylindrical housing are opposite each other. The optical device also includes at least one auxetic structure positioned between the inner wall and an outer wall and connecting the inner wall to the outer wall. The auxetic structure includes at least one bimetallic curved strip, where the at least one bimetallic curved strip includes a first metal strip and a second metal strip. The first metal strip is made of the same metal or have the same coefficient of thermal expansion as the at least one optical device. The second metal strip is made of the same metal or have the same coefficient of thermal expansion as the at least one optical device. The first and second metal strips are made of metals with different coefficients of thermal expansion.

In some embodiments, the optical device includes a plurality of bimetallic curved strips that are positioned end to end in a sequence wherein a direction of curvature for each bimetallic curved strip is positioned opposite the direction of curvature for each adjacent bimetallic curved strip.

### BRIEF DESCRIPTION OF FIGURES

The features of the disclosure are believed to be novel and the element's characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 depicts a side view of an exemplary screw compression embodiment.

FIG. 2 depicts a top view of an exemplary screw compression embodiment.

FIG. 3 depicts a top view of an exemplary embodiment employing rotational nodes.

FIG. 4 depicts an enlarged side view of the exemplary rotational nodes embodiment.

FIG. 5 depicts a top view of a single auxetic structure in the form of a rotational node.

FIG. 6 depicts a side view of an exemplary embodiment of a bimetallic curved strip which flattens when heated.

FIG. 7 depicts a side view of an exemplary embodiment including three bimetallic curved strips which flatten when heated.

FIG. 8 depicts a side view of an exemplary lens embodiment employing a repeated pattern of alternating bimetallic curved strips which flatten when heated.

FIG. 9 depicts a diagram showing that as the temperature rises, the bimetallic curved strips bend at an ever-greater angle.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

The present disclosure is directed to methods for countering undesired thermal expansion and contraction of an optical device through the use of auxetic structures which passively respond to thermal change by undergoing a physical change which is counter to the undesired thermal expansion and contraction of an optical device. Auxetic structures are those which exhibit a negative Poisson ratio. The auxetic structures may be provided within the structure of an optical device or as an added component to the optical device.

In the context herein, the relevant thermal load is applied to the optical device as a whole. Included in the referred to optical device is both the optical components, for example, a lens, housing, and sensory components as well as the auxetic structures.

When the optical device is put under a thermal load, the device can undergo physical changes. For example, the materials which make up the device can expand. Such expansion of materials can, in some instances, be undesirable. For example, expansion can cause the distance between the glass and optical sensor plane of a lens to change resulting in a defocused image. The method herein incorporates auxetic structures in the optical device in a manner whereupon experiencing the same thermal load as the other portions of the optical device, the auxetic structures react to the thermal load in a manner which counteracts the undesirable thermal reaction by the other portions of the optical device.

The optimized result of the method is athermalization of the optical device as a whole. That is, the net result of the physical changes to the auxetic structures and one or more components of the relevant optical system is to minimize or completely cancel out any physical change experienced by the relevant optical system.

The auxetic structures may alternatively be provided to passively and cooperatively undergo a physical change or series of physical changes in response to a change in the thermal load experience by the auxetic structures. The physical changes of the auxetic structures provide a desirable counterbalancing action to an undesirable physical change in one or more components of the relevant optical systems. The net result of these physical changes is to minimize or completely cancel out any physical change experienced by the relevant optical system to which the auxetic structures are a part.

The auxetic structures may be incorporated into the structure of the relevant optical devices by various known methods, for example, various methods of additive manufacturing. Auxetic structures may also be printed directly into the optical housing or retrofitted via a spacer with an auxetic infill geometry.

The figures of the application illustrate specific examples of auxetic structures and devices employing and/or incorporating auxetic structures. The figures also illustrate the method described herein which achieves passive athermalization of an optical device as a whole by employing complementary auxetic structures within the optical device.

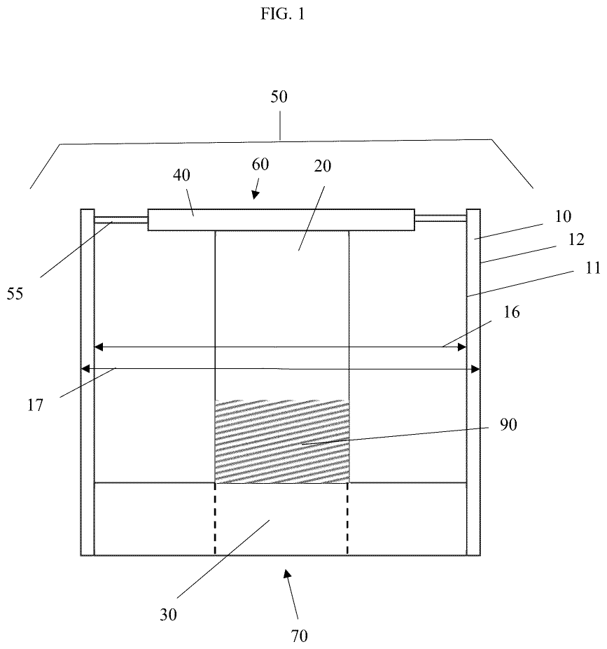

FIG. 1 depicts an exemplary screw compression embodiment with fixed cylinder walls 10. Cylinder walls 10 include inner cylinder walls 11 and outer cylinder walls 12 where the distance between the inner cylinder walls 11 and outer cylinder walls 12 is the thickness of the cylinder walls 10. FIG. 1 shows a screw 20 attached to a nut 30. The head 40 of the screw 20 is connected to the cylinder walls 10 with a series of expansion rods 55. The series of expansion rods 55 in combination with the head 40 of the screw 20, the nut 30, and cylinder walls 10 comprise an auxetic structure 50. When a thermal load is applied to the unit as a whole, the thermal heating results in expansion of all materials of the unit including the expansion rods 55. This expansion lengthens all portions of the unit by some amount, i.e., X %. In the embodiment depicted in FIG. 1, the screw 20 is hollow and when in use, light will pass through the glass portion 60 of a lens to the optical sensor plane 70.

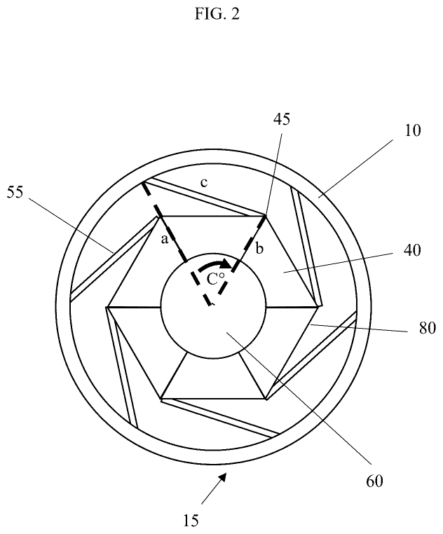

For the optical device to function optimally, the distance between the glass portion 60 of a lens to the optical sensor plane 70 needs to remain unaffected by a thermal load applied to the device as a whole. Any uncompensated expansion of components, for example, the screw 20 which houses the glass portion 60 of the lens, can result in suboptimal performance. Such, suboptimal performance may include a defocused image produced by the optical device. The method's specific application to this embodiment is further explained in FIG. 2.

FIG. 2 is a top view of the exemplary screw compression embodiment. FIG. 2 shows the glass portion 60 of a lens embedded in the head 40 of the screw 20. Several expansion rod structures 55 are positioned around the screw 20 and these expansion rods 55 connect the head 40 of the screw 20 to the cylinder walls 10 and serve as infill of the space between the head 40 of the screw 20 to the cylinder walls 10. The expansion rods 55 are positioned on the side of the flat faces 80 of the screw head. The expansion rods 55 may be positioned in the center of the flat face 80 or offset from the center of each flat face 80. In FIG. 2 the expansion rods 55 are depicted as positioned offset from the center of each flat face 80. When a thermal load, i.e., heat, is applied to the unit as a whole, these expansion rods 55 respond by expanding. The result of this expansion of the expansion rods 55 and the positioning of these expansion rods 55 as shown in the FIG. 2, is that the expansion rods 55 act to rotate the screw 20, for example, clockwise as depicted.

The rotation of the screw 20 results in mechanically pulling the head 40 of the screw 20 closer to the nut 30 which also pulls the glass portion 60 of a lens embedded in the head 40 of the screw 20 closer to the optical sensor plane 70. This screwing action counteracts the expansion of the material of the screw 20 which acts to increase the distance between the glass portion 60 of a lens imbedded in the head 40 of the screw 20 and optical sensor plane 70. The net result of these two actions is that they cancel each other out and the distance between the glass portion 60 of a lens and optical sensor plane 70 does not change.

The material of the auxetic structures 50 and the non-auxetic structures of the optical device can be the same or different. Using the same materials or materials with the same coefficient of thermal expansion can be advantageous as the response to thermal change experienced by these materials, i.e., expansion or contraction will be the same and thus matching complementary action by auxetic structures 50 and the non-auxetic structures of the optical device can be simplified.

Using different materials or materials with different coefficients of thermal expansion can also be advantageous. For example, embodiment depicted in FIGS. 1 and 2, the response between the screw 20 where the optical components are held and the expansion rods 55 can be different. For example, the expansion rods 55 could expand more than the length expansion of the screw 20. Having more length in the radial direction can be needed to counteract the length change in the axial direction of the screw 20 due to thermal expansion. The screw 20 pitch can be selected and/or optimized for a given specific embodiment to provide a known adjustment amount to counteract the thermal expansion of the screw 20 in the axial direction. For example, 5% thermal expansion turns the screw X degrees.

In the embodiment depicted in FIGS. 1 and 2 the relative movement of concern is the distance between the glass portion 60 of a lens imbedded in the head 40 of the screw 20 and optical sensor plane 70. Thus, the expansion rods 55 are provided to counter the axial expansion of the materials. The optical device may experience some radial expansion as well. However, such radial expansion does not affect the distance between the glass portion 60 of a lens and the optical sensor plane 70. Thus, it is not necessary for the expansion rods 55, shown, to counter possible radial expansion of the materials within the unit as a whole. However, countering radial expansion of the materials within the unit as a whole is not excluded from the method as conceived herein.

An illustrative example is provided below to show how rotation of the auxetic screw structure 50 can counter the expansion of the materials of the auxetic screw structure 50 depicted in the embodiment shown in FIG. 1 and FIG. 2. Table 1.1 below provides specific values for each relevant structure shown in FIG. 1 and FIG. 2. Table 1.1 shows how the application of a thermal load sufficient to cause thermal expansion of the auxetic screw structure 50, effects each specific structure of auxetic structure 50 and results in an athermalization effect.

TABLE 1.1

| Screw Head | Screw Center | Push Bar | Housing Inner | Housing Outer | Housing | to | Screw Center to | Screw Center |
|---|---|---|---|---|---|---|---|---|
| Face Length | to Head Corner | Length | Diameter | Diameter | Height | Inner Housing | Inner Housing | Angle C (Deg) |
| 10.00 | 10.00 | 12.00 | 27.00 | 30.00 | 28.70 | 3.50 | 13.50 | 59.20 |
| | b | c | | | | | a | C |
| Screw Head | Screw Center | Push Bar | Housing Inner | Housing Outer | Housing | to | Screw Center to | Screw Center |
| Face Length | to Head Corner | Length | Diameter | Diameter | Height | Inner Housing | Inner Housing | Angle C (Deg) |
| 10.07 | 10.07 | 12.694 | 27.19 | 30.21 | 28.901 | 3.525 | 13.59 | 62.81 |

5.78% Rod Thermal Expansion
0.70% All Other Thermal Expansion
Delta Height = 0.201 Delta Angle = 3.61
Screw Pitch = 20.01 TPI (Threads per inch)

The screw head face length is the length of a screw face 80. The screw center to head corner is the distance from the center of the head 40 of the screw 20 to a corner of the screw head 45. The expansion rod length is the length of an expansion rod 55. The housing inner diameter 16 is the distance between the inner cylinder walls 11. The housing outer diameter 17 is the distance between the outer cylinder walls 12. The housing height is the total axial height of the housing 10 in FIG. 1, which equals the distance from the top of screw head 40 to the bottom of nut 30. The delta height is the difference in the housing height before and after the application of the thermal load. The screw corner to inner housing is the shortest distance between a corner of the screw head and the inner cylinder wall 11. The screw center angle (Deg) defines the center angle C° shown in FIG. 2. The center angle C° is formed by sides a and b of the hypothetical triangle formed by sides a, b, and c in FIG. 2. The sides a, b, and c are also marked in the table above. That is, the screw center to inner housing forms side a, the screw head face length forms side b, and the push bar length forms side c.

The expansion rod 55 length, coefficients of thermal expansion, and pitch of screw thread 90 may be optimized to achieve athermalization of the auxetic screw structure in the axial direction. For example, an auxetic screw structure 50 with the dimensions shown in the table above would increase in axial height by 0.201 inches under a 0.7% thermal expansion load. Selecting expansion rods 50 with a thermal expansion of 5.78% under the same thermal load would turn the screw 3.61° clockwise as shown in FIG. 1. Selecting a screw pitch of 20.01 threads per inch (TPI) exactly counteracts the 0.201 inches thermal expansion of the auxetic screw structure 50 in the axial direction resulting in an athermalization effect.

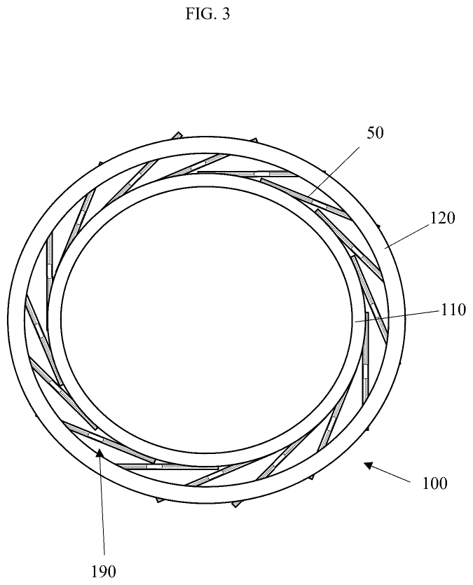

FIG. 3 depicts an exemplary embodiment employing auxetic structures 50 in the form of rotational nodes 190. FIG. 3 is a top down cross-sectional view looking down a cylinder 100 where auxetic structures 50 are provided between an inner 110 and outer 120 side walls and serve as infill for the space between the inner 110 and outer 120 side walls. The amount or number and size of auxetic structures 50 in the form of rotational nodes 190 between the inner 110 and outer 120 side walls can vary.

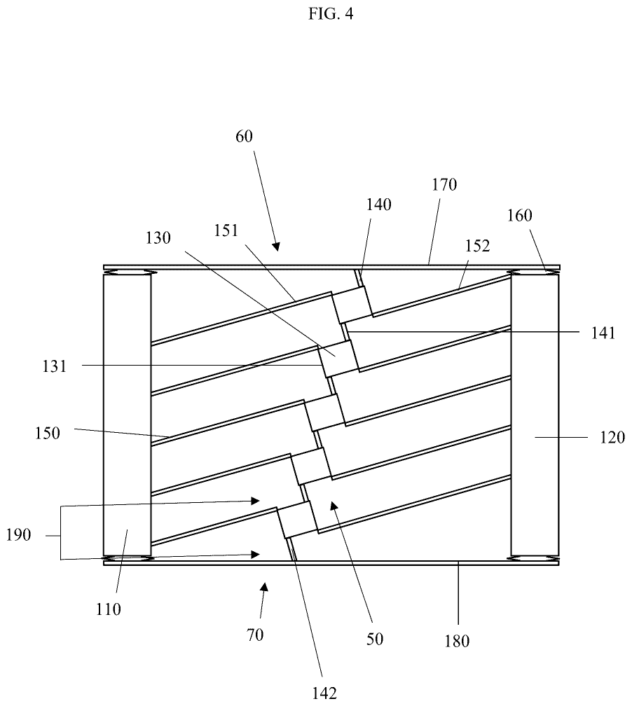

As seen in, for example, FIG. 4, the auxetic structure 50 in the form of rotational nodes 190 may extend vertically through the cylinder 100 parallel to the planes of the glass portion 60 and optical sensor plane 70 which are perpendicular to the optical axis. The method's specific application to this embodiment is further explained in FIG. 4

FIG. 4 depicts an enlarged view of an auxetic structures 50 in the form of rotational nodes 190 from an angle which is perpendicular to that shown in FIG. 3, i.e. a cut away view looking through the side of the cylinder 100.

The auxetic structures 50 in the form of rotational nodes 190 comprise a center portion 130 shown as having a square shape, two short portions 140, and two long portions 150. Thermal heating results in expansion of all materials by some amount, i.e., X %. With specific regard to the short portions 140, and a long portions 150, these portions expand by extending in length. However, the long portions 150 will lengthen more than the short portions 140 simply because it is physically large and thus the same percentage change results in a greater amount of expansion. As can be seen in FIG. 4, the expansion of the short portions 140, and the long portions 150 will result in rotating the square elements, e.g., clockwise, which will mechanically pull the top 170 and bottom 180 portions of the cylinder 100 closer together via the connection of the short portions 140 to the top 170 and bottom 180 of the cylinder 100. The rotation of center portion 130 and subsequent pulling of the top 170 and bottom 180 portions of the cylinder 100 closer together acts to counter thermal expansion in the vertical direction of the unit as a whole.

There may additionally be expansion structures 160 between and connecting the inner 110 and outer 120 side walls to the top 170 and bottom 180 of the cylinder 100. These expansion structures 160 allow for the distances between the inner 110 and outer 120 side walls to the top 170 and bottom 180 of the cylinder 100 to vary but the distance between the top 170 and bottom 180 of the cylinder to remain constant once thermal expansion or contraction materials of the cylinder 100 and the actions of the auxetic structures 50 are taken into account.

For example, when subjected to heat, the space between the inner 110 and outer 120 side walls relative to the top 170 and bottom 180 of the cylinder 100 will shrink as the inner 110 and outer 120 side walls expand. The auxetic structures 50 in the form of rotational nodes 190 rotate their center portion 130 to pull the top 170 and bottom 180 of the cylinder 100 closer together. The net result of the collective actions being that the distance between the top 170 and bottom 180 of the cylinder 100 remains constant, i.e., does not change.

An illustrative example is provided below to show how rotation of the center portion 130 can reduce the total height without affecting the total width of the depicted embodiment in FIG. 4. The tables below provide specific values to represent each portion of the auxetic structures 50 and how the application of a thermal load resulting in 0.3% thermal expansion effects these auxetic structures 50 and the depicted embodiment as a whole.

TABLE 2.1

| | L | L | R | R | T | T | B | B | Box | Box | Box | | Tot | Tot |
|---|---|---|---|---|---|---|---|---|---|---|---|---|---|---|
| Element | Long | Width | Long | Width | Short | Height | Short | Height | Side | Wid | Ht | Angle ° | Wid | Ht |
| 1 | 2.77 | 2.663 | 2.13 | 2.047 | 0.30 | 0.288 | | | 0.50 | 0.618 | 0.618 | 16.0 | 5.329 | 0.91 |
| 2 | 2.56 | 2.461 | 2.34 | 2.249 | 0.30 | 0.288 | | | 0.50 | 0.618 | 0.618 | | 5.329 | 0.91 |
| 3 | 2.35 | 2.259 | 2.55 | 2.451 | 0.30 | 0.288 | | | 0.50 | 0.618 | 0.618 | | 5.329 | 0.91 |
| 4 | 2.14 | 2.057 | 2.76 | 2.653 | 0.30 | 0.288 | | | 0.50 | 0.618 | 0.618 | | 5.329 | 0.91 |
| 5 | 1.91 | 1.836 | 2.99 | 2.874 | 0.30 | 0.288 | 0.40 | 0.385 | 0.50 | 0.618 | 0.618 | | 5.329 | 1.29 |
| | | | | | | | | | | | | | | 4.92 |

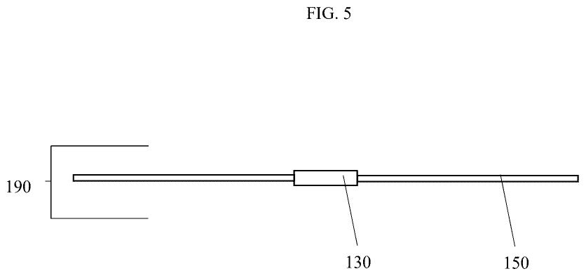

Elements 1-5 refer to each of the five rotational nodes 190 depicted in FIG. 4 and FIG. 5 where Element 1 is the upper most rotational node 190 depicted in FIG. 4 and Element 5 is the lower most rotational node 190 depicted in FIG. 4. The rotational nodes 190 function as a auxetic structure 50.

L Long refers to the length of the specific long portion 151 depicted on the left side of the center portion 130 in FIG. 4. L Width refers to the distance from the point where the left long portion 151 meets the center portion 130 to the left inner side wall 110 along a horizontal plane. R Long refers to length of the specific long portion 152 depicted on the right side of the center portion 130 in FIG. 4. R Width refers to the distance from the point where the right long portion 152 meets the center portion 130 to the right inner side wall 120 along a horizontal plane.

T Short refers to the length of the top short portions 141 positioned at the top of the center portion 130. T Height refers to the distance from the point where the top short portion 141 meets the center portion 130 to the either the top portion 170 (with element 1) or the bottom of a different center portion 130 (with elements 2-5) along a vertical plane.

B Short and B Height apply only to element 5. B Short refers to the length of the short portion 142 positioned at the bottom of the center portion 130 of element 5 which extends to the bottom portion 180. B Height refers to the distance from the point where the bottom short portion 142 meets the center portion 130 to the bottom portion 180 along a vertical plane.

Box side refers to the length of a side 131 of the center portion 130. In the embodiment depicted in FIG. 4, the center portion 130 is a square and thus the length of all sides of the center portion 130 are the same. Box Wid refers to the width of the center portion 130 as depicted in FIG. 4. Box Ht refers to the height of the center portion 130 as depicted in FIG. 4.

Angle° refers to the angle that the central portion 130 has been rotated counterclockwise in FIG. 4. Tot Wid refers to the total width of the element depicted in FIG. 4. Tot Ht refers to the total height of the element.

The values in Table 2.1 above relate to the structure depicted in FIG. 4 when not under a thermal load. The values in Table 2.2 below related to the structure depicted in FIG. 4 when under a thermal load which results in 0.3% Thermal Expansion in all structures depicted in FIG. 4

TABLE 2

| | L | L | R | R | T | T | B | B | Box | Box | Box | | Tot | Tot |
|---|---|---|---|---|---|---|---|---|---|---|---|---|---|---|
| Element | Long | Width | Long | Width | Short | Height | Short | Height | Side | Wid | Ht | Angle ° | Wid | Ht |
| 1 | 2.778 | 2.671 | 2.136 | 2.054 | 0.301 | 0.289 | | | 0.502 | 0.605 | 0.605 | 16.0 | 5.329 | 0.89 |
| 2 | 2.568 | 2.468 | 2.347 | 2.256 | 0.301 | 0.289 | | | 0.502 | 0.605 | 0.605 | 13.5 | 5.329 | 0.89 |
| 3 | 2.357 | 2.266 | 2.558 | 2.459 | 0.301 | 0.289 | | | 0.502 | 0.605 | 0.605 | | 5.329 | 0.89 |
| 4 | 2.146 | 2.063 | 2.768 | 2.661 | 0.301 | 0.289 | | | 0.502 | 0.605 | 0.605 | | 5.329 | 0.89 |
| 5 | 1.916 | 1.842 | 2.999 | 2.883 | 0.301 | 0.289 | 0.401 | 0.386 | 0.502 | 0.605 | 0.605 | | 5.329 | 1.28 |
| | | | | | | | | | | | | | | 4.86 |

The definitions above apply also to Table 2.2. Comparing the data in Table 2.1 with the data in Table 2.2 shows that while the e.g., lengths of the structures increased, the total width of the element remained unchanged. However, the total height of the element was reduced along with the amount of clockwise rotation of the center portion 130.

This example and Tables 2.1 and 2.2 illustrate the function of the auxetic structures 50 to counteract the expansion of the material of the relevant structures due to experiencing a thermal load. As illustrated in Tables 2.1. and 2.2, a thermal load will result in the rotation of the central portion 130 in a manner which will reduce the overall height of the element. This reduction in height is matched to counteract the increase in distance between the top 170 and bottom 180 of the cylinder 100 which is cause by extension of materials, e.g., the sidewalls 110 and 120 when under a thermal load. The net result being that the distance between the top 170 and bottom 180 of the cylinder 100 do not change and athermalization is achieved.

FIG. 5 depicts a top view of a single auxetic structures 50 in the form of rotational nodes having a center portion 130 and the long portion 150. The short portion 140 is not visible from this view. The long portions 150 are depicted in FIG. 5 as being centered on the center portion 130. Centering the long portions 150 on the center portion 130 prevents any out of plane rotation relative to the view. Expansion of the long portions 150 exert a force on the center portion 130 causing it to rotate. The short portions 140 are similarly positioned, as seen in FIG. 4, whereby the rotation of the center portion 130 also exerts pulling force on the top 170 and bottom 180 of the cylinder 100 through the short portions 140.

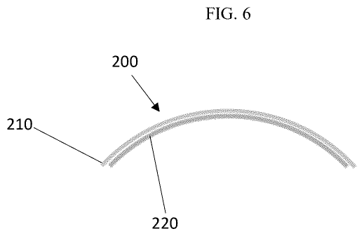

FIG. 6 shows an exemplary embodiment employing bimetallic curved strips 200 which flatten when heated. The bimetallic curved strips 200 are comprised of a first metal strip 210 and a second metal strip 220. The first metal strip 210 and a second metal strip 220 are different metals. The first metal strip 210 may be made of the same metal or have the same coefficient of thermal expansion as the structure of which it is a part of or of which it is integrated to. The second metal strip 220 may be made of the same metal or have the same coefficient of thermal expansion as the structure of which it is a part of or of which it is integrated to.

The first metal strip 210 and the second metal strip 220 have different coefficients of thermal expansion. That is, the two different metals expand at different rates as the temperature changes. This differences in thermal expansion results in the strip bending or straightening. In the exemplary embodiment shown, the second metal strip 220 will expand more than the first metal strip 210 when exposed to a thermal load causing the bimetallic curved strips 200 to reduce its curvature.

Examples of acceptable metals include but are not limited to, for example, aluminum, steel, copper brass, iron, nickel, and alloys thereof, for example, nickel-iron alloy and copper-nickel alloy.

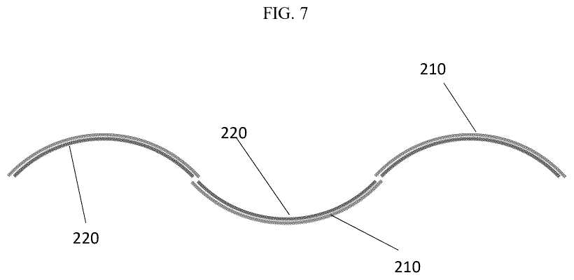

FIG. 7 shows three of the structures of FIG. 6 combined into a single continuous structure. Gaps between each segment of the bimetallic curved strips 200 are illustrated in the figure so as to clearly depict the joints of the adjacent bimetallic curved strips 200, but one skilled in the art will understand that the ends of the bimetallic curved strips 200 are joined together in a continuous structure.

As shown in FIG. 7, the endpoints of the bimetallic curved strips 200 may not be even and thus, when arranged in the pattern depicted in the figure, adjacent bimetallic curved strips 200 can join together such that the longer first metal strip 210 meets the end of the shorter second metal strip 220 in such a manner that there may be a small overlap in the longer first metal strips 210 of adjacent bimetallic curved strips 200. In alternative embodiments, the ends of each bimetallic curved strips 200 may be even, i.e., neither the first metal strip 210 nor the second metal strip 220 is longer in the curved configuration and in other alternative embodiments, the second metal strip 220 may be longer in the curved configuration.

The bimetallic curved strips may be positioned end to end in a sequence where a direction of curvature for each bimetallic curved strip is oriented opposite the direction of curvature of each adjacent bimetallic curved strip such that an end of the first metal strip is positioned adjacent to an end of the second metal strip of each adjacent bimetallic curved strip. This creates a wave like pattern the bimetallic curved strips alternate in forming either a peak or trough of the wave like pattern.

The first metal strip 210 and the second metal strip 220 in each bimetallic curved strip 200 have different coefficients of thermal expansion. That is, the two different metals expand at different rates as the temperature they are exposed to changes. The two different expansion rates cause the bimetallic curved strip 200 to bend or straighten. In the exemplary embodiment shown, the second metal strip 220 will expand more than the first metal strip 210 when exposed to a thermal load causing the bimetallic curved strip 200 to straighten out. Each of the individual bimetallic curved strips 200 undergo this described straightening under a thermal load. The straightening of each of the curved strips 200 results in the entire continuous structure of bimetallic curved strip 200 flattening and thereby losing height.

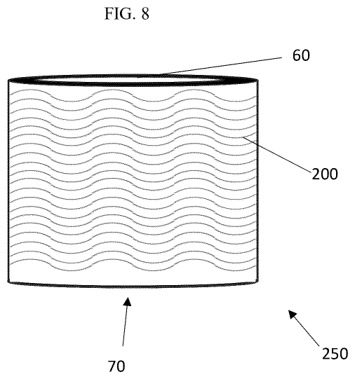

For illustrative purposes, such a principle is applied in, for example, electrical switches for a thermostat. When an electrical switch for a thermostat receives a thermal load, one of the first metal strip 210 or the second metal strip 220 will expand more than the other causing the strip to bend. In context of an electrical switch, the stripe will bend away from an electrical contact disrupting the circuit and switching the device off. The concept of having bimetallic curved strip 200 bend or straighten in response to a thermal load is similar in the current application but the concept is newly applied to an auxetic structure. An exemplary embodiment of such auxetic structure is shown in FIG. 8.

FIG. 8 depicts a cylinder 250, for example, a lens, with bimetallic curved strips 200 in the pattern shown in FIG. 7 incorporated into its structure. In a cylindrical lens embodiment, the height of the lens is defined as the distance between the glass portion of the lens 60 and the optical sensor plane 70. When exposed to a thermal load, the second metal strip 220 will expand more than the first metal strip 210 when exposed to the same thermal load. Bimetallic curved strips 200 will therefore straighten out, as discussed above. The result is that the bimetallic curved strips 200 act to exert a force to reduce the height of the cylinder.

At the same time that the bimetallic curved strips 200 are acting to exert a force to reduce the height of the cylinder, the materials of cylinder 250 are also experiencing and responding to the thermal load by expanding. The net result of the force of expansion of the cylinder 250 and the force applied by the bimetallic curved strips 200 cancels out in the vertical illustrated direction, i.e., the axial direction or height of the cylinder. Some radial expansion may occur.

In the context of an optical device, the cylinder 250 may represent a lens or housing for optical components. Expansion in the axial direction is not desirable as this can cause the distance between the glass portion 60, for example, positioned at the top of cylinder 250 and optical sensor plane 70 positioned at the bottom of cylinder 250, to change. The change in distance between the glass portion 60 and optical sensor plane 70 can result in a blurred image. The method herein incorporates auxetic structures in the form of bimetallic curved strips 200 in the optical device 250 in a manner whereupon experiencing a thermal load, the auxetic structures 200 react to the thermal load in a manner which counteracts the undesirable thermal reaction by the other portions of the optical device 250. The collective actions of expansion of the materials of the structure and the vertical contraction of the auxetic structures, results in the distance between the glass portion 60 and optical sensor plane 70 undergoing no net change. For the purposes of this application, no net change in distance between the glass portion 60 and optical sensor plane 70 is defined as an amount of distance which does not materially affect the performance of the relevant optical device.

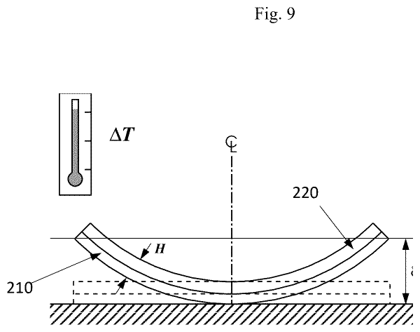

FIG. 9 depicts a diagram showing that as the temperature rises, the bimetallic curved strips 200 bend at an ever-greater angle. By reversing the order of the first metal strip 210 and the second metal strip 220 or by reversing the order of which metal stirp 210 or 220 has the greater co-efficient of thermal expansion one can provide a bimetallic curved strip 200 which bends or straightens in either direction from its center in response to increasing temperature.

For example, to provide a bimetallic curved strip 200 which straightens when exposed to increasing temperatures, one would position the first metal strip 210 or second metal strip 220 with the greater co-efficient of thermal expansion on the top side of a bimetallic curved strip 200 when not under thermal load. As shown, in FIG. 9, the second metal strip 220 would be the metal with the greater co-efficient of thermal expansion. Such an arrangement of a bimetallic curved strip 200 which straightens under thermal load is depicted in FIG. 9.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A method for passive athermalization in optical systems comprising:
providing at least one auxetic structure in at least one optical device, wherein the at least one optical device has at least one glass portion and at least one optical sensor plane spaced at a distance from each other,
exposing the at least one optical device to a thermal load,
wherein the at least one optical device expands under the thermal load and increases the distance between at least one glass portion and at least one optical sensor plane,
wherein the at least one auxetic structure expands under the thermal load and reduces the distance between at least one glass portion and at least one optical sensor plane,
wherein the combination of the expansion of the at least one optical device and the expansion of the at least one auxetic structure results in no net change in distance between the at least one glass portion and as least one optical sensor plane.

2. The method of claim 1, wherein the at least one auxetic structure in the at least one optical device comprises:
a hollow screw positioned within a housing wherein the at least one glass portion is positioned at the head of the screw and the at least one optical sensor plane is positioned on a nut which is attached to the threads of the screw which are positioned at the bottom portion of the screw,
at least one expansion rod wherein the at least one expansion rod connects the head of the screw to the housing,
wherein the expansion of the at least one expansion rod under the thermal load results in rotation of the screw in a direct which reduces the distance between the head of the screw and the nut.

3. The method of claim 2, wherein a plurality of expansion rods connect the screw head to the housing.

4. The method of claim 3, wherein the plurality of expansion rods are positioned on the side of each flat face of the screw head.

5. The method of claim 1, wherein the at least one auxetic structure in the at least one optical device comprises:
a cylindrical housing comprising an inner wall, an outer wall, at least one glass portion is positioned at a first end of the cylindrical housing, and at least one optical sensor plane positioned at a second end of the cylindrical housing wherein the first and second ends of the cylindrical housing are opposite each other,
at least one auxetic structure positioned between the inner wall and an outer wall and connecting the inner wall to the outer wall,
wherein the expansion of the at least one auxetic structure under the thermal load results in force which pulls the top and bottom of the cylindrical housing closer together.

6. The method of claim 5, wherein the at least one auxetic structure comprises:
at least one center portion,
at least one long portion, and
at least one short portion,
wherein the at least one long portion is connected to the at least one center portion and one of the inner wall, or outer wall of the cylindrical housing,
wherein the at least one short portion is connected to one of the at least one center portion and to a second center portion or to the first or second end of the cylindrical housing.

7. The method of claim 6, wherein the center portion is in the shape of a square and
wherein the connections of the at least one long portion and the at least one short portion to the at least one center portion are positioned in the center of the at least one center portion.

8. The method of claim 6, wherein a plurality of one auxetic structures are provided in sequence between the first and second ends of the cylindrical housing.

9. The method of claim 5, wherein the inner wall and outer wall of the cylindrical housing are connected to the first and second ends of the cylindrical housing via at least one expansion structure.

10. The method of claim 9, wherein the at least one expansion structure compresses or expands in response to the pulling force of the at least one auxetic structure and is suitable for allowing for the distances between the inner and outer side walls and the first and second ends of the of the cylindrical housing to vary but the distance between the first and second ends of the cylindrical housing remains constant when under thermal load.

11. The method of claim 1, wherein the at least one auxetic structure in the at least one optical device comprises:
at least one bimetallic curved strip positioned between at least one glass portion positioned at a first end of the optical device, and at least one optical sensor plane positioned at a second end of the optical device.

12. The method of claim 11, wherein the at least one bimetallic curved strip comprises:
a first metal strip and
a second metal strip,
wherein the first metal strip is made of the same metal or has the same coefficient of thermal expansion as the at least one optical device,
wherein the second metal strip is made of the same metal or has the same coefficient of thermal expansion as the as the at least one optical device, and
wherein the first and second metal strips are made of metals with different coefficients of thermal expansion.

13. The method of claim 12, wherein at least one optical device comprises a plurality of bimetallic curved strips.

14. The method of claim 13, wherein the plurality of bimetallic curved strips are positioned end to end in a sequence wherein a direction of curvature for each bimetallic curved strip is oriented opposite the direction of curvature of each adjacent bimetallic curved strip such that an end of the first metal strip is positioned adjacent to an end of the second metal strip of each adjacent bimetallic curved strip.

15. The method of claim 14, wherein the sequence of the plurality of bimetallic curved strips positioned end to end extends around a circumference of the optical device.

16. The method of claim 15, wherein the at least one optical device comprises a plurality of bimetallic curved strips sequences, wherein the plurality of bimetallic curved strips sequences are arranged along an optical axis of the at least one optical device and perpendicular to direction of the end to end bimetallic curved strips in a single sequence.

17. An optical device comprising:
a cylindrical housing comprising an inner wall, an outer wall, at least one glass portion is positioned at a first end of the cylindrical housing, and at least one optical sensor plane positioned at a second end of the cylindrical housing wherein the first and second ends of the cylindrical housing are opposite each other,
at least one auxetic structure positioned between the inner wall and an outer wall and connecting the inner wall to the outer wall,
wherein the auxetic structure comprises:
at least one center portion,
at least one long portion, and
at least one short portion,
wherein the at least one long portion is connected to the at least one center portion and one of the inner wall, or outer wall of the cylindrical housing,
wherein the at least one short portion is connected to one of the at least one center portion and to a second center portion or to the first or second end of the cylindrical housing.

18. The optical device of claim 17 wherein the inner wall and outer wall of the cylindrical housing are connected to the first and second ends of the cylindrical housing via at least one expansion structure.

19. An optical device comprising:
a cylindrical housing comprising an inner wall, an outer wall, at least one glass portion positioned at a first end of the cylindrical housing, and at least one optical sensor plane positioned at a second end of the cylindrical housing wherein the first and second ends of the cylindrical housing are opposite each other,
at least one auxetic structure positioned between the inner wall and an outer wall and connecting the inner wall to the outer wall,
wherein the auxetic structure comprises at least one bimetallic curved strip, wherein the at least one bimetallic curved strip comprises:
a first metal strip and
a second metal strip,
wherein the first metal strip is made of the same metal or have the same coefficient of thermal expansion as the at least one optical device,
wherein the second metal strip is made of the same metal or have the same coefficient of thermal expansion as the at least one optical device, and
wherein the first and second metal strips are made of metals with different coefficients of thermal expansion.

20. The optical device of claim 19 wherein the optical device comprises a plurality of bimetallic curved strips that are positioned end to end in a sequence wherein a direction of curvature for each bimetallic curved strip is positioned opposite the direction of curvature for each adjacent bimetallic curved strip.
